(19) United States
(12) Patent Application Publication
(10) Pub. No.: US 2012/0227306 A1
(43) Pub. Date: Sep. 13, 2012

(54) Powered duck decoy and garden displays

(76) Inventor: Stanley Fong, Sacramento, CA (US)

(21) Appl. No.: 12/932,815

(22) Filed: Mar. 8, 2011

(51) Int. Cl. A01M 31/06

(52) U.S. Cl. 43/3

(57) ABSTRACT

A power module gear coupled to a wind operated fowl hunting decoy, which is normally wind powered, such that the decoy's wings will rotate during periods of no wind. The power module has a body that internally carries one or more batteries, controlled by a switch to operate a small motor in the head of the module on the shaft of which is a gear that engages a gear disposed on the decoy's wing shaft Gear alignment means and module mounting means are also provided. The module will also power wind operated garden ornaments by suitable mounting adaptation.

### FIELD OF THE INVENTION

This patent application relates to a power adaptor for use with wind operated duck decoys.

### BACKGROUND OF THE INVENTION

Every duck hunter knows that he or she must take steps to bring the ducks to the blind or other area where the hunter is lurking in order to make a kill. That is, it is necessary to lure the ducks to the hunter's whereabouts. One way to do so is through the use of duck decoys. One of the most common duck attractors is the Winduk™. The Winduk has a composite body with two opposed wings that spin on a metal shaft in the wind, when the wind is over 5 mph. The problem arises when there is little or no wind. The wings do not rotate and the lack of motion of the decoy fails to attract the birds to the hunter's whereabouts. Other decoys may have a metal body with wings.

Applicant experienced this problem of no wind on numerous occasions, and of course he brought home no birds on such days. Thus he set out on how to overcome the lack of wind with his Winduk and other similar decoys. This invention is the result of his efforts and will supply power to both goose and duck decoys.

Applicant also realized that the device he had invented can also be used as a power source for wind vanes, that is articles that have a series of vanes mounted on a shaft , which shaft is rotated by the wind. Two examples that come to mind are a windmill and a helicopter, both of which are often seen in models up to about 4 feet tall in gardens

The invention accordingly comprises the device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### SUMMARY OF THE INVENTION

This invention is a power module that has a body which holds an on-off switch and retains a battery based power source to operate a motor disposed at the upper end of the body. The motor is coupled through a gear system to the wing shaft of the decoy to enable the wing shaft to rotate when the power is applied to the motor independent of the presence of wind.

It is a first object to provide a power source for the operation of a Winduk or similar duck decoy.

It is a second object to provide a battery operated motor that couples to the duck decoy whereby the wings of a rotating wing decoy will rotate without the benefit of wind.

It is a third object to provide a handheld power system for Winduk brand duck decoy.

It is a fourth object of this invention to provide a unique power module that couples to a gear system to provide power to an object.

It is a fifth object to provide a power module for any vane carrying shaft apparatus which is intended to be rotated by wind power at such times as there is no wind.

Other objects of the invention will in part be obvious and will in part appear hereinafter.

### BRIEF DESCRIPTION OF THE FIGURES

FIG. 1 is a right side closeup elevational view of the device of this invention.

FIG. 2 is a left side closeup elevational view of the power module of this invention.

FIG. 3 is a left front perspective view of the power module of this invention coupled to a rotatable shaft's gear.

FIG. 4 is a left front elevational view of the power module of this invention coupled to a Winduk's wing shaft.

FIG. 5 is a top view showing the modifications made to a winged duck decoy to enable the coupling of the power module of this invention.

FIG. 6 is a left front perspective view showing the device of this invention coupled to the wing shaft of a Winduk brand decoy wing shaft.

FIG. 7 is an elevational view showing the exterior and interior of the battery housing and power head of the device of this invention.

FIG. 8 is a diagrammatic view of this power module in a coupled position.

FIG. 9 is a diagrammatic view of this power module showing the exterior & interior of the battery housing & motor head of the device of this invention.

FIG. 10 is a side elevational view of a garden windmill with the power module of this invention coupled thereto.

FIG. 11 is a perspective view of a duck decoy modified to accept the device of this invention.

### DESCRIPTION OF THE PREFERRED EMBODIMENT

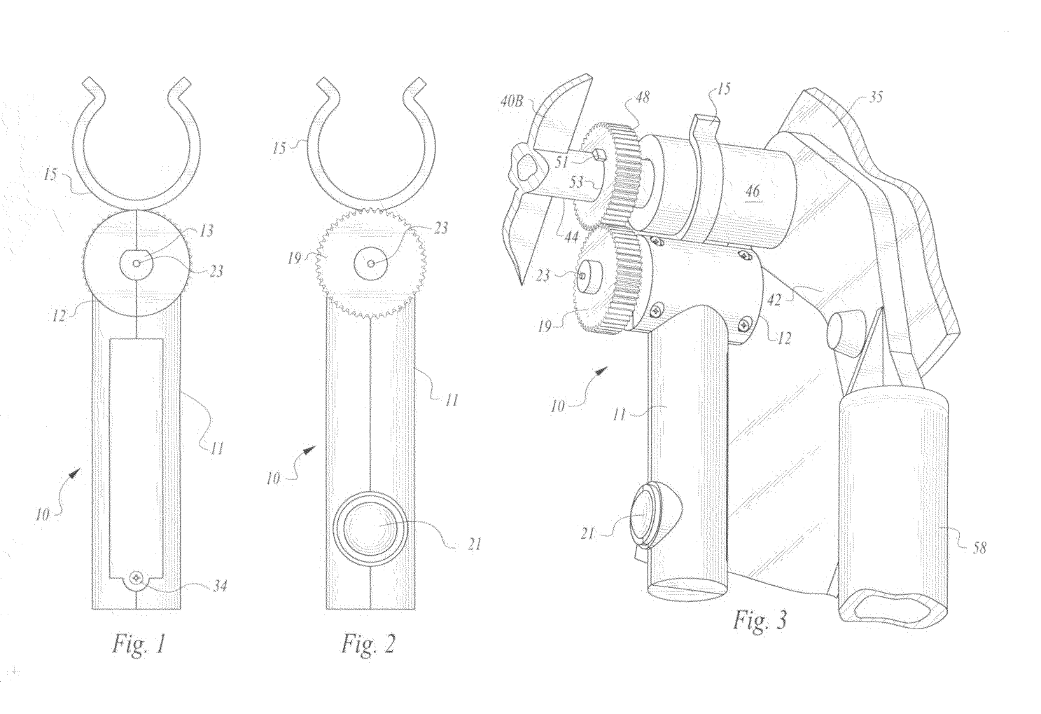

The reader is urged to turn now to FIG. 1 which is a right side elevational view of this invention 10. Device 10 has a main body 11, which as will be explained is used to carry batteries and a circuit board. Body 11 is tubular and intended to carry 1 or 2 AA size batteries according to the circuit design employed. Obviously circuitry utilizing a 9 volt battery or some other power source are envisioned as well. Disposed at a right angle or normal to the main body and integrated therewith is the power head 12 which contains the motor as seen best in FIG. 3. A shaft retainer 13 is disposed on one end of the power head. The purpose of the shaft retainer is to anchor or hold the shaft 23, on which sits gear 19, as may be seen in FIG. 3. The edge of the shaft 23 can be seen in FIG. 1.

Disposed on the upper surface of the head 12 is clip 15, which is a generally U-shaped spring clip for receiving a tubular member as will be described below.

FIG. 2 is a view similar to FIG. 1, but is from a 180 degree different vantage point and is designated a right elevational view. In this view the on off switch 21, disposed at or near the bottom of the main body can be seen. This switch is electrically connected to the circuitry for operating the device. Of course, the on-off switch 21 can be located at any other suitable position on the body as may be desired. If the edge of the shaft 23 seen in FIG. 1 is deemed the distal end then the end seen in FIG. 2 is designated the distal end of the shaft. Gear 19 is seen mounted in any conventional manner to the metal shaft 23. If the gear is made of thermoplastic material, then a simple fusing as by heat or solvent application can achieve the task. Preferably a set screw disposed in shaft 23 will retain the gear, which may also be metal.

In FIG. 3, the view here is a perspective view which includes the left side of the device. A tubular sleeve 46 is shown disposed in the U-shaped clip 15. Wing shaft 44 of the prior art Winduk™ decoy is disposed through the central opening 53 of gear 48 and is connected on the other end, the unseen end of the right wing 40A. This shaft as can be seen emanates from wing 40B of the decoy.

An optional stop 51 can be attached to or secured upon the wing shaft 44 of the decoy duck wing 40B to help maintain the gear in position and to properly align the placement of the left wing 41 of the decoy relative to gear48. The two duck wings 40A and 40B can also be referred to as BLADES, since they are configured for rotation by the wind or applied power as in this invention. This wing shaft 44 passes through the hollow sleeve 46 and the decoy body member 42, as will be discussed further in conjunction with FIG. 5.

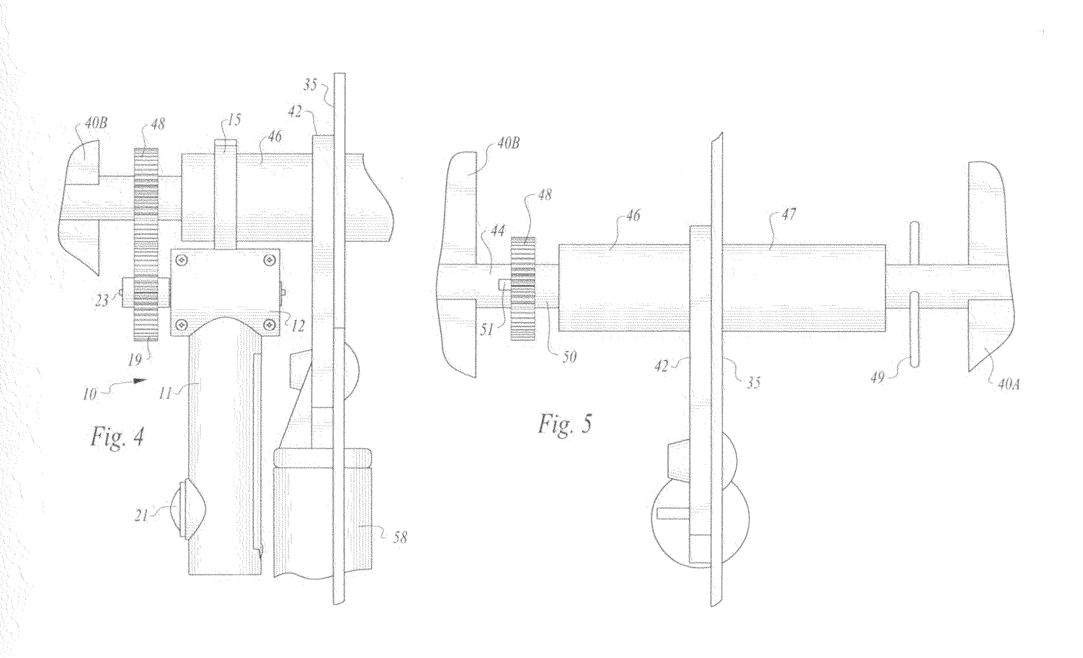

Reference is now made to FIG. 4, which is somewhat similar to FIG. 3, but from a different perspective. Here one gains a better insight into to gear system which consists of gear 19 which engages gear48. Note the distal end of the shaft upon which gear 19 is mounted. One can also better understand the shape of the body member 42 of the decoy, which is affixed to the decoy body 35 seen here in FIG. 4 as well as in FIG. 3. Body member 42, which is of course part of the prior art decoy is seen to be disposed in or attached to a base 35. Any suitable base 35 may be employed to retain the decoy 14 in a position for blade rotation subsequent to the minor adaptation followed by the application of the power system of this invention.

As has been inferred, the decoy 14, per se, forms no part of the present invention. The Winduk™ decoy must be modified as is being discussed in order to operate with the power system of this invention.

In FIG. 5, the body member 42 is seen disposed between the two sleeves 46 &47. Whereas the left side of the body member 42 has a sleeve 46 and a spacer 50 , not visible in other FIGURES due to the angle of view, and the stop 51 for alignment purposes, the right side of the member 42 has the smaller sleevette 47 retained in place by a cotter pin 49 disposed through a suitable unnumbered aperture in the wing shaft 44 adjacent the outer end of the sleevette 47. Sleevette 47 is disposed abutting the decoy body 35. used to add balance to the shaft in light of the presence of sleeve 46. Body member 42 seen in FIG. 4, is also seen here in FIG. 5 in an edge view.

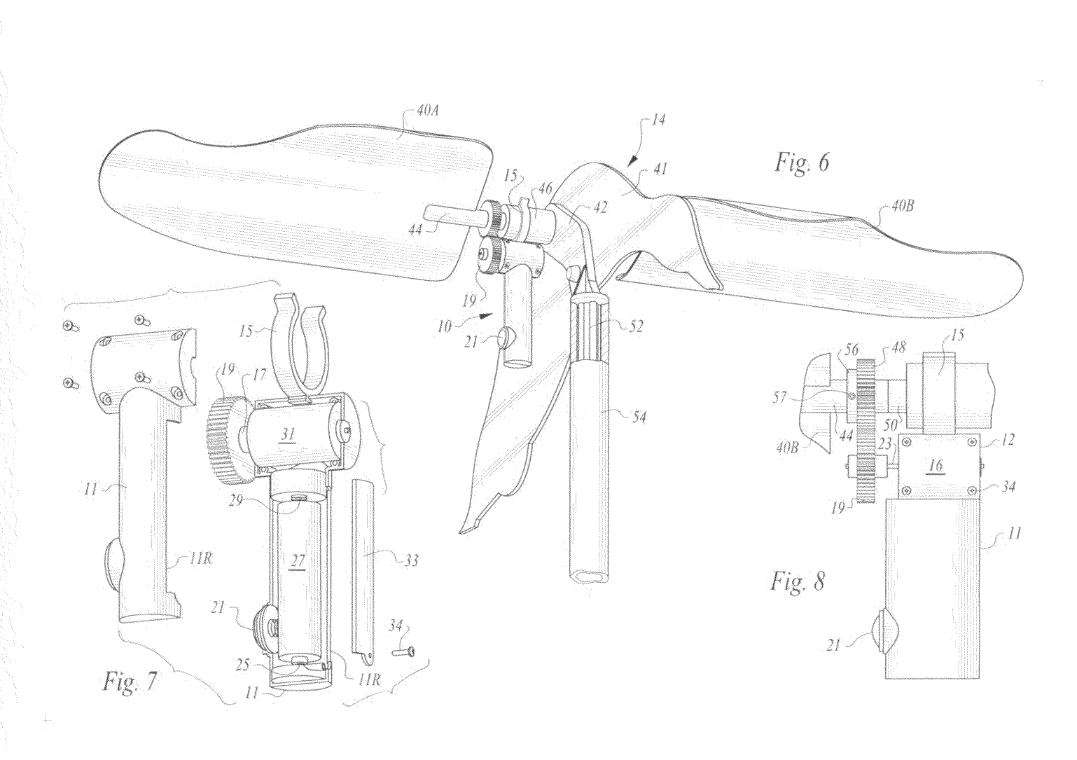

In FIG. 6, the entire decoy 14 is seen. The aerodynamic blade 40A is seen in its entirety as well as sleeve 46 with the addition of device 10 of this invention engaged via the spring clip 15 to the sleeve 46. Here the mount 52 is shown in cutaway disposed in the mounting tube 54. As can be appreciated the decoy can be a duck as noted or a swan, or a goose as may be available in the marketplace.

FIG. 7 relates to the internal aspects of this invention. Cover plate 33 which is a cast metal or molded plastic item is removably attached by a series of set screws—one of which 34, is seen in FIG. 1—at several convenient locations. Alternatively the cover plate can be snap fit to the body 11, a technique well known in the plastic industry.

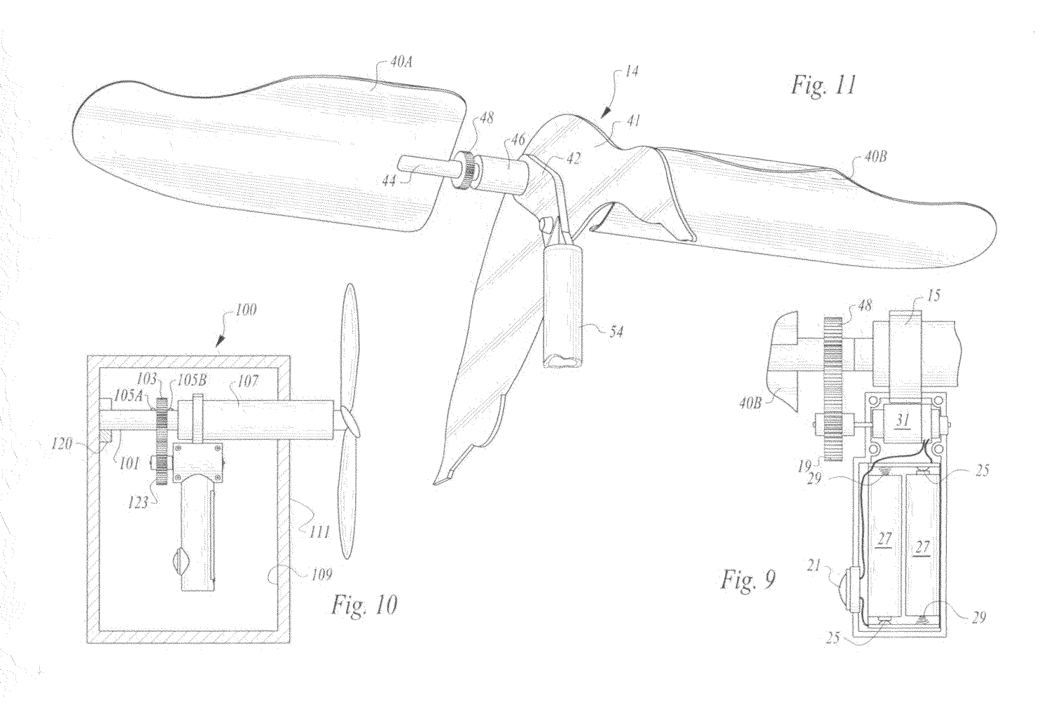

An electrical positive contact 25 is seen at the bottom of the body distant from the head. A single battery , preferably an AA Lithium Ion battery is disposed within an internal concave recess 11R, in the body 11. A conventional coil spring negative contact 29 is disposed at a conventional location at the distal end of the battery. The two contacts are conventionally connected to the motor 31 through the on-off switch 21, a simple circuit well known in the electronics field. When actuated, via switch 21, the battery 27 supplies the power needed to operate the motor 31. Reference is made specifically to FIG. 9, wherein an optional 2 battery power means, 55 is shown, with power flowing through switch 21. Here two AA batteries are employed.

Returning now to FIG. 7, it is seen that shaft 23 of the motor is connected to gear 19 such that the gear will rotate in one direction. It is within the skill of the art to provide means for the shaft to rotate both clockwise and counterclockwise and such is anticipated, since the direction of the rotation of the wings will be controlled by the direction of the wind.

In FIG. 8, the body 11 is seen with the on-off switch 21 located at the bottom aligned in a plane with gear 19. The switch 21 can be placed at any other convenient location if desired. Head cover 16 of head 12 is also seen to be attached by set screws 34 at convenient locations. The head 12 serves as a housing for the motor 31. Motor shaft 23 is seen connected to tooth gear 19. Gear48 is disposed on a shaft not seen as such shaft is overlaid by spacer 50 to ensure a correct alignment with gear 18 for engagement therewith. This shaft not fully seen, is really the shaft 44 of the decoy shown in FIG. 5. A retainer 56 held by a set screw 57, is also disposed on the shaft 44. The retainer is employed to help secure gear 48 and the sleeve 46 disposed with in the yoke or clip 15 in proper alignment laterally. The yoke or clip may be a spring steel or flexible plastic member, sized to be removable, holds onto the sleeve while the shaft disposed there through rotates.

Shaft 44 passes thought he hollow sleeve and the body member 42 which body member is attached to the decoy body, as is discussed supra. The right side of the decoy body is shown in FIG. 5, wherein the sleevette 47 held by the cotter pin also serve as alignment means to prevent the shaft 44 from sliding within the sleeve and sleevette. The balance of FIG. 9 contains elements previously discussed.

In FIG. 10 a garden windmill 100, having an interior 109 and a front wall 111 is seen. Here the shaft 101 has its rear edge disposed in a U shaped rest 120. One merely urges the shaft forwardly away from the rest 120, adds a sleeve 107 if not present, correctly locates and disposes the gear 103 at a suitable location on the shaft 101. The user then engages the U-clip onto sleeve 107 and the gear 123 to mount the power module in place for operation. The set screw 105 retains the gear in place on the shaft adjacent the sleeve.

In order to ensure that the clip is fabricated strongly enough to endure in wind rain and other weather conditions, it is suggested that the clip be at least ⅛th inch thick, & ⅝th inch wide. Of course for the same reason, the battery power section in the body 11 and the head 12 and the switch 21 must be made water proof as by the use of rubber gaskets as is well known in the art.

In order to have a decoy that simulates the wing movements of a real duck or other water fowl, they should rotate at a rate of about 200 rpm. While there will be some drag due to the weight and mass of the decoy wings, motors are available that will provide this speed of rotation of the shaft 23.

In one unit made specifically for the Winduk brand fowl decoy the body was 2.75 inches high by 0.75 inches in diameter. The power shaft was 0.125 inches in diameter. The motor housing was 1.33 inches long by about 1 inch in diameter. The gears for both the power module and the wing shaft of the decoy were both about 1 inch in diameter and made of a plastic such as Delrin®.

Garden wind operated windmills and other wind operated ornamental displays can employ the same or larger modules. Scaling of the entire device and motor size determination are within the skill of the art.

In conclusion, it is seen that it is easy to modify a conventional decoy to utilize the device of this invention. One merely separates the left wing on the shaft from the right wing and inserts the gear 48 after adding spacer 50. The wing shaft is then re-installed into sleeve 46. The U-clip is attached to the sleeve, such that the gear 19 engages gear 48.

As to a garden display such as the windmill of FIG. 10, the mode of adaptation to accept the power module of this invention is set forth supra, and as can be seen is substantially the same as the modification of a duck decoy.

In order to ensure that the clip is fabricated strongly enough to endure in wind rain and other weather conditions, it is suggested that the clip be at least ⅛th inch thick, & ⅝th inch wide. Of course for the same reason, the battery power section in the body 11 and the head 12 and the switch 21 must be made waterproof as by the use of rubber gaskets as is well known in the art.

In order to have a decoy that simulates the wing movements of a real duck or other water fowl, they should rotate at a rate of about 200 rpm. While there will be some drag due to the weight and mass of the decoy wings, motors are available that will provide this speed of rotation of the shaft 23.

In one unit made specifically for the Winduk brand fowl decoy the body was 2.75 inches high by 0.75 inches in diameter. The power shaft was 0.125 inches in diameter. The motor housing was 1.33 inches long by about 1 inch in diameter. The gears for both the power module and the wing shaft of the decoy were both about 1 inch in diameter and made of a plastic such as Delrin®.

Garden wind operated windmills and other wind operated ornamental displays can employ the same or larger modules. Scaling of the entire device and motor size determination are within the skill of the art.

In conclusion, it is seen that it is easy to modify a conventional decoy to utilize the device of this invention. One merely separates the left wing on the shaft from the right wing and inserts the gear 48 after adding spacer 50. The wing shaft is then re-installed into sleeve 46. The U-clip is attached to the sleeve, such that the gear 19 engages gear 48.

As to a garden display such as the windmill of FIG. 10, the mode of adaptation to accept the power module of this invention is set forth supra, and as can be seen is substantially the same as the modification of a duck decoy.

FIG. 11 is a perspective view showing the device of this invention mounted in position to the wing of a Winduk brand decoy. Note however that in this view the device is mounted on the right wing, contrary to its positioning in other FIGURES. Thus it is seen that the device may be mounted on the left or right wings as may be desired with equally satisfactory results. The determination of where to mount the device may often be made on site where the hunter is positioned for hunting. All of the aspects of the device having been described previously, further discussion is deemed unnecessary.

Since certain changes may be made in the described apparatus without departing from the scope of the invention herein involved, it is intended that all matter contained in the above description and shown in the accompanying drawings shall be interpreted as illustrative and not in a limiting sense

I claim:

1. A power module gear to be coupled to a wind operated fowl hunting decoy, which decoy is normally wind powered, such that the decoy's wings will rotate during periods of no wind, said power module comprising a body having a power head mounted thereon, which body internally carries one or more batteries, and a control switch to control the battery power of said module to operate a motor, having a motor shaft, disposed in the power head, on the shaft of which motor is a gear that will engage a gear disposed on a decoy's wing shaft.

2. The device of claim 1 further including gear alignment means to ensure engagement of the module gear and the decoy mounted gear.

3. The device of claim 2 further including means to mount the power module to a decoy for gear engagement.

4. The device of claim 3 wherein the means to mount the power module is a U-shaped clip attached to the power head.

5. The device of claim 1 wherein there is a single AA battery disposed in the body.

6. The device of claim 2 where there are 2 AA batteries are disposed in the body.

7. In combination, a power module gear coupled to a wind operated fowl hunting decoy, which decoy is normally wind powered, such that the decoy's wings will rotate during periods of no wind,
said power module comprising a body having a power head mounted thereon, which body internally carries one or more batteries, and a control switch to control the battery power of said module to operate a motor, having a motor shaft, disposed in the power head, on the shaft of which motor is a gear that will engage a gear disposed on a decoy's wing shaft,
said decoy having a pair of mirror image wings mounted on a shaft, which shaft is disposed through the body of the decoy for rotation in the wind, said shaft having a gear disposed thereon in alignment with the gear of the power module.

8. The combination of claim 7 wherein the means of coupling is a U-shaped clip mounted on the power head of the power module, which clip engages a sleeve retained on the wing shaft of said decoy.

9. The device of claim 8 wherein there is a single AA battery disposed in the body.

10. The device of claim 7 where there are 2 AA batteries are disposed in the body.

11. In combination, a power module gear coupled to a wind operated garden windmill, which windmill is normally wind powered, such that the vanes of the windmill will rotate during periods of no wind, when power from the power module is applied,
said power module comprising a body having a power head mounted thereon, which body internally carries one or more batteries, and a control switch to control the battery power of said module to operate a motor, having a motor shaft, disposed in the power head, on the shaft of which motor is a gear that will engage a gear disposed on a drive shaft of a windmill having a series of vanes mounted on the drive shaft, and
said windmill comprising a housing having a series of vanes mounted at one end of a drive shaft, external to the housing, the shaft passing through the housing, and having a gear disposed on said drive shaft in alignment with the gear of said power module.

12. In the combination of claim 11, wherein the windmill is replaced by a garden helicopter comprising a housing having a series of vanes mounted at one end of a drive shaft, external to the housing, the shaft passing through the housing, and having a gear disposed on said drive shaft in alignment with the gear of said power module.

13. The combination of claim 11 wherein the means of coupling is a U-shaped clip mounted on the power head of the power module, which clip engages a sleeve retained on the power shaft of the wind powered garden accessory.
